(19) United States
(12) Patent Application Publication
(10) Pub. No.: US 2012/0208604 A1
(43) Pub. Date: Aug. 16, 2012

(54) WIRELESS REMOTE CONTROL WITH A TOUCH INTERFACE FOR HANDS-FREE TELEPHONY AND MULTIMEDIA EQUIPMENT OF A MOTOR VEHICLE

(75) Inventors: Jean-Francois Vuillet, Versailles (FR); Fabrice Barriez, Reillanne (FR); Marc Flambard, Luzancy (FR)

(73) Assignee: PARROT, Paris (FR)

(21) Appl. No.: 13/356,424

(22) Filed: Jan. 23, 2012

(30) Foreign Application Priority Data
Feb. 10, 2011 (FR) 1151058

(51) Int. Cl. H04M 1/00

(52) U.S. Cl. 455/569.2

(57) ABSTRACT

The remote control includes a central button and side buttons. Touch sensors are associated with each of the buttons, with the central button being associated with a multizone touch pad that is activatable in different manners as a function of the movement of the finger over said pad. A set of pushbutton electromechanical switches is provided, comprising a central switch and one side switch in common for the buttons of each pair of side buttons. Selector means serve, on detecting a state transition of a side switch, to select a control signal as a function of that one of the touch sensors that is activated by contact with one of the side buttons associated with the switch. The movement of the finger over the central button is analyzed in order to distinguish between rectilinear movement and circular movement of the finger, and in order to determine the direction of said movement.

### FIELD OF THE INVENTION

The invention relates to a wireless remote control having a touch interface for “hands-free” telephony and multimedia equipment of a motor vehicle.

### BACKGROUND OF THE INVENTION

Such a remote control is for use in controlling a piece of equipment proper that is generally placed on the dashboard, at a location that is often too far away from the driver for it to be easy for the driver to reach it without hindering driving. That is why that equipment is associated with a remote control for facilitating access to the commands for the basic functions of the equipment.

Such a wireless remote control is particularly suitable for equipment that is “retrofitted” on a vehicle.

The remote control may be fastened to the steering wheel or to a support that is stuck to the dashboard and within reach of the driver's hand. The use of wireless transmission for commands makes it possible in particular for the remote control to be mounted on the steering wheel in the form of an element that is attached thereto, without requiring any wire connected to the equipment.

For a simple “hands-free” telephony function, the number of commands needed is relatively small: answering/hanging up, calling a voice recognition function, controlling volume.

In contrast, the arrival of new pieces of equipment with an ever-increasing number of functions and controls makes it difficult to implement such a remote control.

New-generation equipment generally incorporates options for coupling the audio system of the vehicle not only with a hands-free telephony installation but also with a sound playback appliance such as an MP3 player, or indeed an audio storage medium such as a “USB key” or an “SD card” or some other medium. In addition to having commands specific to telephony, it is then necessary for the user to have commands available such as: selecting a sound source, selecting the next/preceding track, playing back or pausing, fine adjustment of sound volume, etc.

Unfortunately, it is essential for a remote control that can be handled by the driver of a motor vehicle to be extremely ergonomic, and the remote control must fit in well with the driving environment while maintaining the safety and pleasure of driving.

In particular, controls in the form of an extra element fastened to the steering wheel run the risk of impeding driving, in particular if it is necessary for the driver to think and look away from the road in order to select which button of the remote control to actuate.

Furthermore, the controls must be in the immediate proximity of the driver's hand under all circumstances, but that must not lead to them being actuated inadvertently.

### OBJECT AND SUMMARY OF THE INVENTION

The object of the invention is to remedy those difficulties, by providing a remote control:
that is capable of retaining small dimensions in spite of a large number of different commands, in such a manner as to enable it to be installed very discreetly so as to impede manipulation of the steering wheel very little;
that is of mechanical design that enables it to be made in simple and robust manner;
that has all of its functions accessible to a single finger, e.g. a thumb, without it being necessary for the hand to let go of the steering wheel; and
that prevents commands being sent in involuntary manner while driving the vehicle, by requiring certain specific mechanical actions or by guiding the driver's finger in order for commands actually to be sent.

As described below, the invention makes it possible to provide such a remote control that enables a large number of commands to be concentrated on a very small area, by making the following possible (by way of example and in non-limiting manner):
answering the telephone for an incoming call;
hanging up at the end of a call;
changing music source;
launching the voice recognition function (in particular for calling a directory in order to dial a telephone number, or indeed for searching for a music track);
starting/stopping music playback;
increasing/decreasing sound volume;
playing the next track; and
playing the preceding track.

It must be possible with one finger to control all of those functions by means of controls that are incorporated in a minimum amount of space, in a manner that is very ergonomic to use and that hinders very little in spite of the remote control being fitted onto the steering wheel of the vehicle.

To this end, the invention provides a wireless remote control comprising, in known manner: a casing having a body supporting a visible face having a plurality of zones forming control buttons with a plurality of touch sensors associated with each of the buttons; means for selectively producing control signals as a function of a corresponding button actuated by a user; and radio transmitter means for transmitting messages to remote equipment containing the control signals.

In a manner characteristic of the invention, the visible face includes a central button and at least one pair of side buttons arranged on a side of the casing, and the remote control further comprises a set of electromechanical pushbutton switches, with one side switch in common for the buttons in each pair of side buttons. The visible face is movable and/or deformable relative to the body of the casing in such a manner as to enable each side switch to be actuated selectively by exerting a force on one or the other of the buttons in the pair of side buttons corresponding to the switch. The central button comprises a multizone touch pad that is activatable in different manners as a function of the movement of a finger of the user over the surface of the pad. The remote control also includes selector means suitable, on detecting a state transition of a side switch, for selecting a control signal as a function of that one of the touch sensors that is activated by contact being made with one of the side buttons of the pair of buttons associated with the switch.

According to various subsidiary characteristics that are advantageous:
the remote control includes two pairs of side buttons arranged symmetrically on either side of the central button, with each pair having a common side switch associated therewith;
the central button is movable and/or deformable in the pressing-in direction relative to the body of the casing, and a central electromechanical pushbutton switch is also provided that can be actuated by pressing in said central button;
the central button extends in a mean plane that is set back relative to the mean plane of the buttons in the visible face of the casing;
the visible face is formed on a cover of the body of the casing, the cover carrying two pairs of side buttons that are arranged symmetrically on either side of the central button, and being hinged to the body of the casing about a pivot axis that extends along a diameter of the central button and that forms an axis of symmetry for the two pairs of side buttons;
means are provided for analyzing the movement of the user's finger over the surface of the multizone touch pad, said means making it possible to distinguish between a rectilinear movement and a circular movement of the finger, and to determine the direction of said circular or rectilinear movement;
an accelerometer is also provided that makes it possible to determine the orientation of the casing of the remote control in an absolute frame of reference, and making it possible, where necessary, to reverse direction of the rectilinear movement, as indicated, as a function of the orientation;
the means for analyzing the movement of the user's finger over the surface of the multizone touch pad are means implemented either by a circuit incorporated in the casing, or else by a circuit in the remote equipment, the radio transmitter means then being suitable for transmitting signals representative of the movement of the user's finger over the multizone touch pad;
the remote control includes means for inhibiting the production of the control signals in the event of simultaneously detecting: i) a movement of a user's finger over the surface of the multizone touch pad; and ii) a contact on at least one of the touch sensors associated with the side buttons;
the touch sensors are capacitive sensors, and means are provided for periodically reading the states of said sensors and for activating the means for producing the control signals and the radio transmitter means only in the event of detecting activation of one of the capacitive sensors as a result of contact by a user's finger; and
the remote control further includes lighting means associated with each pair of side buttons, and means for selectively and temporarily activating the lighting means on the approach of a user's finger being detected by one of the touch sensors associated with said buttons.

### BRIEF DESCRIPTION OF THE DRAWINGS

There follows a description of an embodiment of the device of the invention given with reference to the accompanying drawings in which the same numerical references designate, from one figure to another, elements that are identical or functionally similar.

FIG. 1 is an overall view from above in perspective of the remote control of the invention, shown as it appears to the user when mounted on the steering wheel of the vehicle.

FIG. 2 is a section view of the remote control on II-II of FIG. 1.

FIG. 3 shows the remote control with its cover open, revealing the various capacitive touch sensors and circuit elements, in particular the pushbutton switches.

FIG. 4 shows the body of the remote control with the electronic circuits and the flexible spring piece that serves to control the touch effect when a finger acts on the pivoting cover.

FIG. 5 is a plan view of the flexible circuit carrying the various capacitive touch sensors, showing the configuration of these various sensors in detail.

FIG. 6 is a block diagram of the various functional elements of the remote control circuit of the invention.

FIG. 7 is a flow chart showing the various steps of the algorithm executed by the microcontroller of the remote control in order to analyze the signals delivered by the sensors and the switches.

FIG. 8 shows a typical example of the signal delivered by one of the capacitive sensors of the multizone touch-sensitive pad.

FIG. 9 is a flow chart of the various steps of the algorithm executed by the microcontroller of the remote equipment in order to analyze the movement of the finger on the multizone touch-sensitive pad.

### MORE DETAILED DESCRIPTION

In the figures, there can be seen a remote control given overall reference 10 for use in controlling “hands-free” telephony and multimedia equipment, enabling the driver of a motor vehicle to send or receive a telephone call without letting go of the steering wheel, and in similar manner to start or stop playing a source of music, to increase or decrease the playback volume, to change to the preceding or the following track, etc.

The remote control 10 comprises a casing essentially constituted by a body 12 enclosing the various electronic circuits and closed by a cover 14 with a visible top face that carries the various control buttons. The body 12 of the casing of the remote control 10 is fastened to the steering wheel 16 by means of a strap 18 that enables the casing 10 to be attached to the location selected by the driver, generally within reach of a thumb at the place where the driver holds the steering wheel.

The outside dimensions of the casing of the remote control 10 may for example be of the order of 50 millimeters (mm)×46 mm so as to enable it to be installed discreetly on the steering wheel so as to ensure that handling of the steering wheel is hindered very little.

The remote control 10 has a central button 20 of circular shape that operates in a manner described in greater detail below, together with two pairs 22 and 24 of side buttons arranged on opposite sides of the remote control, symmetrically about a central axis 26. The pair 22 of side buttons may comprise for example a button 22a corresponding to the answer function and a button 22b corresponding to launching the voice recognition function, these two buttons 22a and 22b preferably being of similar dimensions and being arranged symmetrically to each other about an axis perpendicular to the central axis 26. Similarly, the pair 24 of side buttons comprises, arranged in the same manner, a button 24a for hanging up and a button 24b for selecting the audio source that is to be played.

The central button 20 is advantageously arranged with a shoulder 28 that is set back relative to the outside surface of the cover, i.e. relative to the various keys 22a, 22b, 24a, and 24b.

This set-back arrangement presents two advantages:
it enables the driver to find the central button 20 on the remote control merely by touching it with a thumb, without looking at the remote control, and thus without glancing away from the road; and
when a finger is placed on the central button, the button guides the movement of the finger, in particular to enable the end of the finger to move circularly on the button (the movements of the finger on the central button are described in greater detail below).

It is thus possible to use the remote control without looking. This tactile sensation may be further increased by giving the central button 20 a slightly curved dome shape, as can be seen in the section of FIG. 2.

The casing is also provided with light-emitting diodes (LEDs) 30 and 32, e.g. a green LED 30 on the answer button and a red LED 32 on the hang-up button, in order to enable the remote control to be used simply in a low-light environment. Advantageously, these LEDs 30 and 32 are powered (in a manner explained below) only when the approach of a finger close to any of the central or side buttons 20 or 22a, 22b, 24a, 24b is detected.

FIG. 2 shows more clearly how the cover 14 is hinged to the body 12 of the casing. The cover is movable in pivoting about a middle axis 34 so as to enable it to tilt a little to the left (using the conventions of FIG. 2) by pressing 36 on one or the other of the side buttons 22a or 22b, or to the right by pressing 38 on one or the other of the buttons 24a and 24b. The cover 14 has only one degree of freedom relative to the body 12, such that pressing the button 22a or the button 22b has exactly the same effect in terms of how the cover moves relative to the body 12 (arrows 40), with the same applying to the buttons 24a and 24b.

The cover 14 is a single-piece element that is engaged on the body 12 by means of an anti-extraction snap-fastener system 42 enabling the two parts 12 and 14 to be assembled together without slack.

Thus, when the side buttons 22 or 24 are actuated, the reaction forces come: i) firstly from the resilient return effect of the element situated under the cover (an electromechanical switch or pushbutton, as described below); and ii) secondly from the deformation of the cover 14. Controlled deformation of the parts made of plastics material thus serves to increase and manage the force required for actuating the controls, so as to prevent any involuntary operation of the controls as a result of the system being too sensitive.

Concerning the mechanical arrangement of the central button 20, it is movable by being pushed in (arrow 44), so as to be capable of triggering a function by being pushed in axially as a result of a finger pressing on said central button 20.

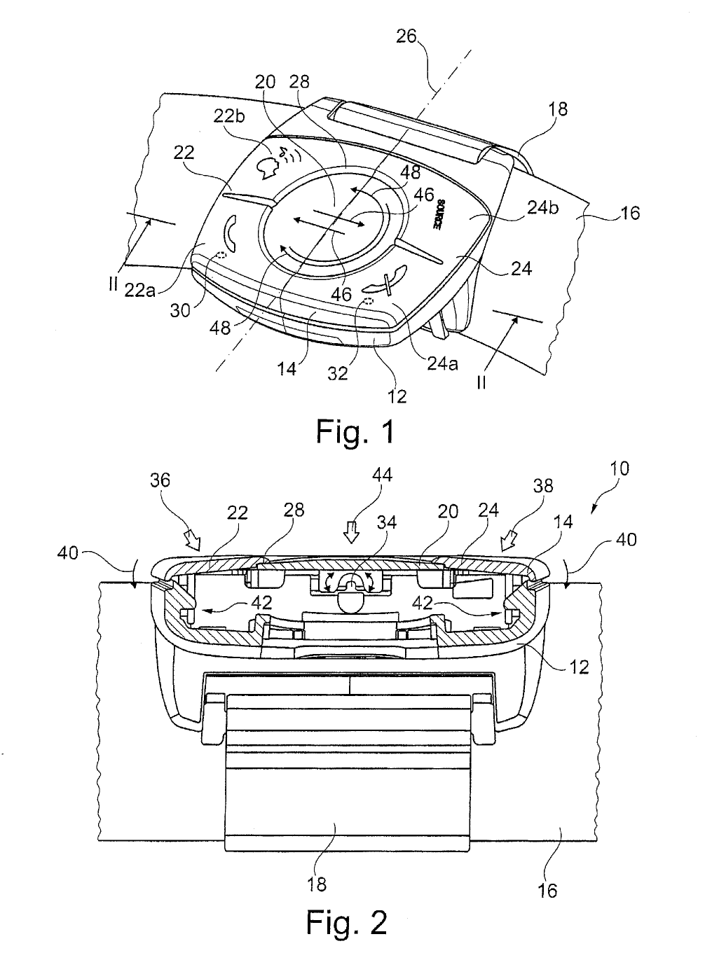

Because of its circular shape, the central button 20 also makes it possible to detect movements of the finger either by sliding from left to right or vice versa (arrow 46 in FIG. 1), or else by the finger moving circularly in a clockwise or a counterclockwise direction (arrows 48 in FIG. 1), which movement is guided by the shoulder 28 where the central button 20 is set back relative to the remainder of the cover.

The central button 20 thus makes the following controls possible:
starting/stopping the playing of music, by pressing in the button (arrow 44);
moving to the next or preceding track by sliding in a straight line across the central button 20 to the right or to the left (arrows 46); and
increasing/decreasing volume by a rotary movement of the finger on the touch zone (arrows 48).

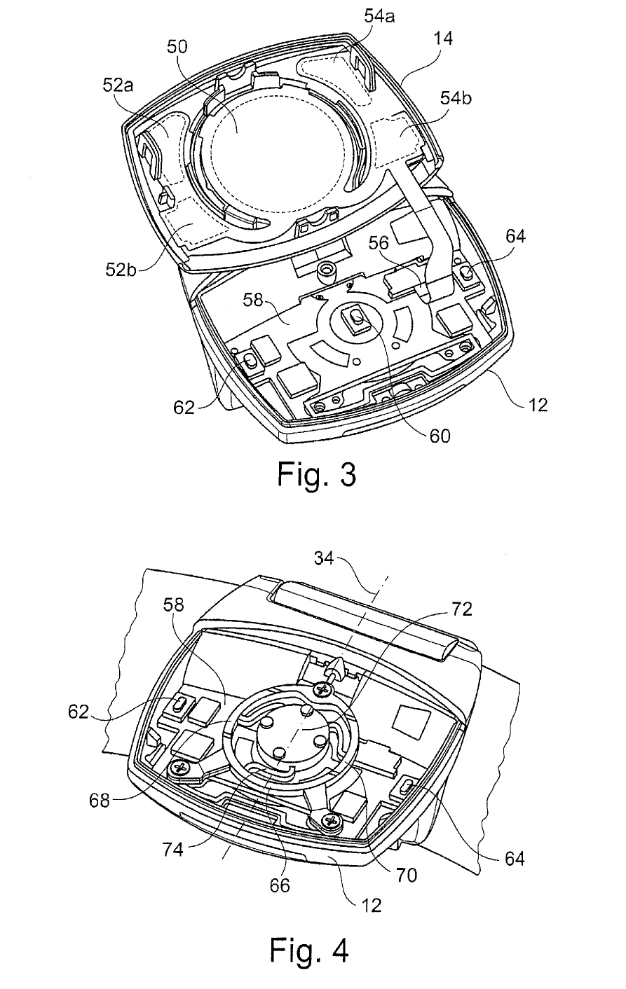

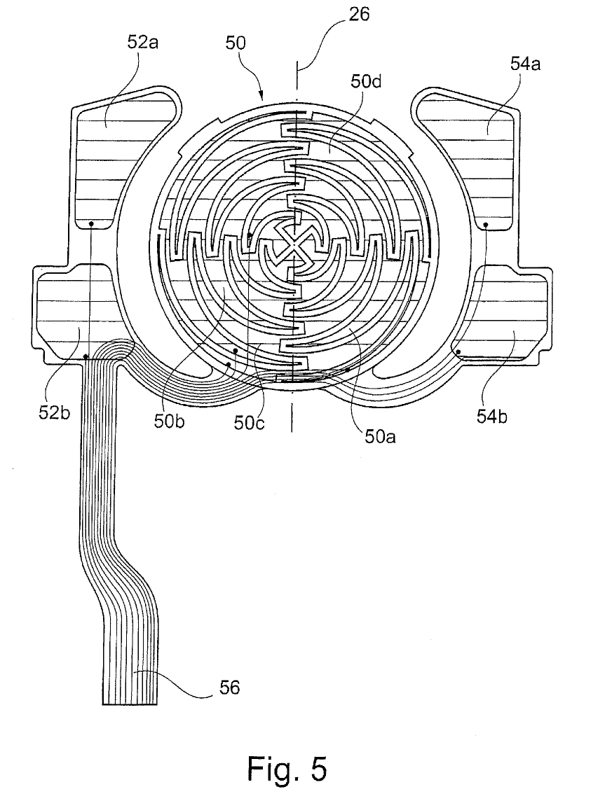

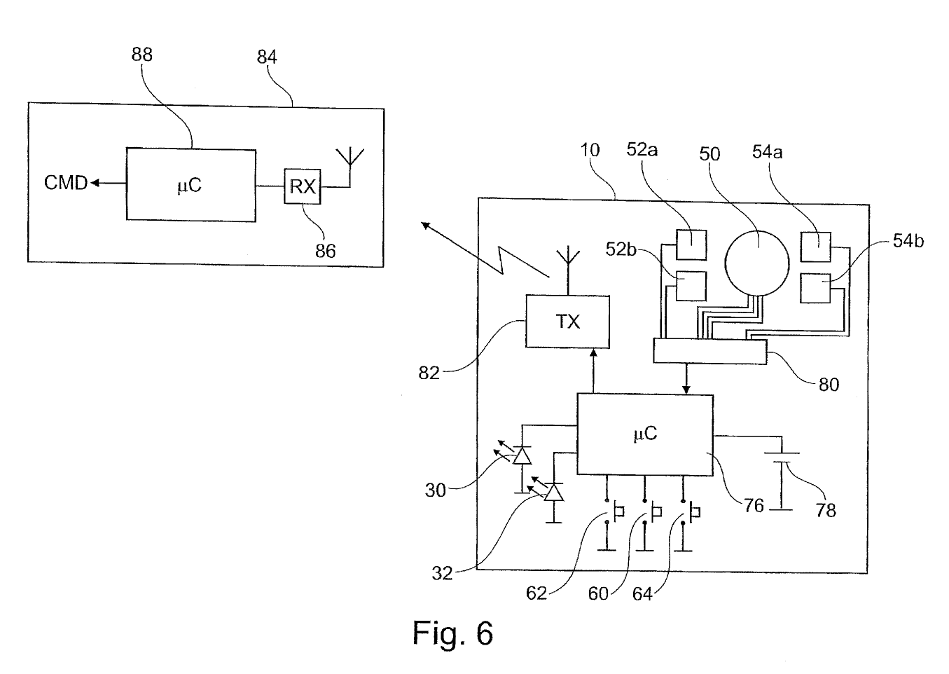

FIG. 3 shows the casing with the cover 14 open. The cover carries a set of capacitive touch sensors 50 and 52a, 52b, 54a, 54b on its inside face, the sensors being arranged respectively in register with the central and side buttons 20 and 22a, 22b, 24a, 24b. These touch sensors, of shapes that are described in greater detail below with reference to FIG. 5, are carried by a flexible printed circuit arranged on the inside face of the cover 14. This flexible printed circuit is extended by a series of conductors terminating in a connector 56 that is connected to the circuit 58 arranged inside the body 12 of the casing and carrying the various electronics components of the remote control.

In particular, the circuit 56 carries three electromechanical pushbutton switches, namely: a central switch 60 situated in register with the central button 20 (when the cover 14 is closed on the casing 12); a side switch 62 situated in register with the pair 22 of side buttons 22a and 22b, being common to both of these buttons; and a side switch 64 situated in register with the pair 24 of buttons 24a and 24b, and common to both of these buttons.

The central switch 60 is actuated by pressing axially on the central button 20 (arrow 44 in FIG. 2). The side switch 62 is actuated by pressing on either of the side buttons 22a or 22b (arrow 36 in FIG. 2) as a result of the cover 14 pivoting (arrow 40) on the body 10 when one or the other of these buttons is pressed. In like manner, the side switch 64 is actuated by pressing on either of the side buttons 24a or 24b (arrow 38 in FIG. 2) as a result of the cover 14 pivoting on the body 10 when one or other of these buttons is pressed.

When the switches 60, 62, 64 are actuated by any of the above-mentioned movements, they deliver feedback to the user both in tactile form (a sensation of the pushbutton being pushed in suddenly) and in audible form (a click), thereby enabling activation of the command to be confirmed by non-visual means.

The pushbutton switches 60, 62, 64 also act by means of the springs associated with their operating rods to ensure a return effect on the buttons. This return effect may be increased by the deformation of the parts made of plastics material when it is the side buttons 22a, 22b, 24a, or 24b that are involved, as explained above, thereby making the system less sensitive to involuntary actuation.

It is also possible to provide an additional spring piece 66, shown in FIG. 4, that is mounted on the body 12 of the casing and that presents flexible resilient side elements 68 and 70 that provide an additional spring effect. Concerning the central button, the spring piece 70 carries a central element 72 in contact with the central button, and decoupled from the casing and the resilient elements 68 and 70 by flexible arms 74 that likewise provide a spring effect against the pressure applied to the central button, thus enabling the conditions for actuating the button to be controlled accurately.

FIG. 5 shows in isolation the flexible printed circuit that carries the various touch sensors 50 and 52a, 52b, 54a, 54b.

The side sensors 52a, 52b, 54a, 54b are configured so that once the flexible circuit has been put into place inside the cover, these sensors are in register with the respective buttons 22a, 22b, 24a, and 24b, so as to detect selectively any contact made by a finger with one or another of these four buttons.

The regions of the flexible circuit carrying the sensors 52a and 52b are connected to the central sensor 50 by a bridge, with the same applying to the region carrying the sensors 54a and 54b. These two bridges allow the central pushbutton, and thus the central sensor 50 to move relative to the remainder of the cover.

Concerning the sensor 50, it is placed in register with the central button 20 and presents a special configuration using four individual sensors 50a, 50b, 50c, and 50d. By way of example, this sensor is a multizone touch-sensitive pad of the overlapping type (i.e. with overlapping zones), comprising four zones that are distributed in approximately symmetrical manner over four quadrants. This component is itself a component of known type (e.g. sold by Cypress Semiconductor Corp.) and has been selected because it enables excellent discrimination to be made between movements while using only four sensors, and thus while analyzing only four signals, thereby requiring calculation means that are greatly reduced compared with a matrix type sensor for which movement is much more difficult to analyze. It should be observed that instead of using a four-zone sensor it is possible to use a three-zone sensor (three sectors arranged at substantially 120°), but at the cost of reduced precision.

The sensor 50 delivers four values corresponding to the various zones 50a, 50b, 50c, and 50d, referred to below as “raw values”. Precision is of the order of 15%.

This sensor having a multizone touch pad is particularly well suited to detecting rotary movements of a finger tip (arrows 48 in FIG. 1), or detecting rectilinear movement of the finger across the central button (arrows 46). The algorithm for distinguishing between movement in translation and movement in rotation, and for determining the direction of the movement in rotation or in translation is described in greater detail below.

FIG. 6 is a block diagram showing the various elements of the electronic circuit of the casing of the remote control 10.

It is driven by a low-consumption microcontroller 76 that is powered by a button type battery 78. The microcontroller is connected to the three switches 60, 62, and 64 so as to detect their states (pressed or released); it is also connected to the various capacitive touch sensors 50 (with its four zones 50a to 50d) and 52a, 52b, 54a, 54b, via an interface circuit 80. The microcontroller is also coupled to a radio transmitter circuit 82 for transmitting commands, e.g. at a frequency of 433 megahertz (MHz).

The transmitter circuit 82 transmits signals to remote equipment 84 coupled to the multimedia equipment that is to be controlled, or incorporated therein. The remote equipment 84 comprises a receiver circuit 86 for receiving the signals transmitted by the transmitter 82 of the remote control 10, which signals are transmitted to a microcontroller 88 that enables commands CMD to be delivered for controlling the multimedia equipment and the hands-free telephone equipment: answering/hanging up, increasing/decreasing volume, selecting sound source, next/preceding track, etc.

In order to be more flexible in terms of changes in algorithm, and in order to avoid too much calculation being performed by the microcontroller 76 of the remote control 10, since its battery lifetime needs to be preserved, only some of the command detection processing is performed within the remote control 10, the remainder being performed within the remote equipment 84, by its microcontroller 88.

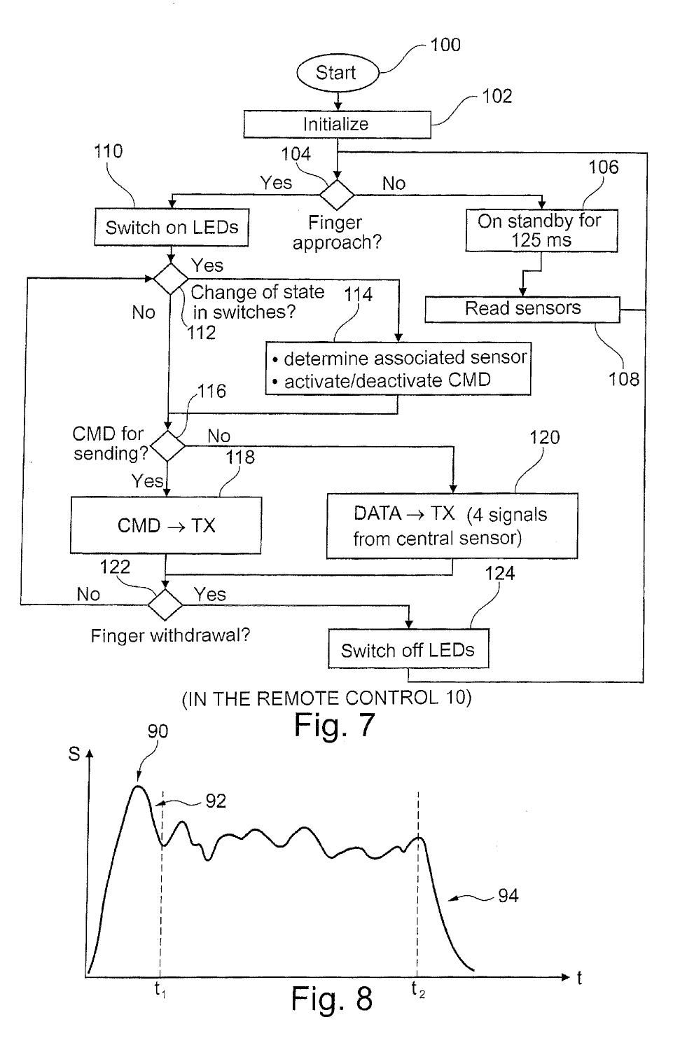

More precisely, as described in greater detail below with reference to FIGS. 7 to 9, the movement of a finger on the central touch sensor 20 is detected and analyzed remotely by the microcontroller 88 of the remote equipment 84, with this analysis requiring relatively complex algorithms to be implemented. The remote control 10 then does no more than transmit to the remote equipment 84 the raw signals (after being digitized) as delivered by each of the sub-sensors 50a to 50d. In contrast, the states of the pushbutton switches 60, 62, and 64 and the states of the touch sensors that are associated with the pairs 22 and 24 of side buttons are analyzed directly by the microcontroller 76 of the remote control 10.

There follows a description of the manner in which the remote control of the invention operates.

One of the original features of the system of the invention lies in the combination of: i) touch sensors—i.e. a multizone sensor for the central button 20 and a respective sensor for each of the four side buttons 22a, 22b, 24a, 24b; and ii) three pushbutton switches—i.e. a central switch 60 associated with the central button 20, a side switch 62 associated with the pair of buttons 22a and 22b, and another side switch 64 associated with the pair of buttons 24a and 24b.

It should be observed that for each of the switches 62 and 64 there are two touch-sensitive zones associated with a single switch: respectively the zones 22a, 22b for the switch 62, and 24a, 24b for the switch 64.

In order to confirm that a command is to be taken into account, contact with any one of the four buttons 22a, 22b, 24a, 24b must be confirmed by the corresponding switch being pushed in and changing state.

This makes it possible to obtain a system that is both compact (one switch is used in common with two buttons) and less sensitive to involuntary commands (because of the need to combine detection via a touch sensor with detection of a change in the state of the switch). In addition, pushing in the switch gives tactile and audible feedback to the user (feeling and hearing a “click”), thereby enabling the command to be confirmed.

It should also be observed that the central button 20 on its own serves to issue five different commands:
playing or stopping playing (a central press on the button, serving to actuate the switch 60);
next track (sliding a finger from left to right);
preceding track (sliding a finger from right to left);
increase volume (a finger turning clockwise); and
decrease volume (a finger turning counterclockwise).

Preferably, for the next/preceding track commands, the remote control includes an accelerometer. It is advantageous to be able to detect the orientation in three-dimensional space of the remote control relative to an absolute frame of reference, and to enable the two functions to be reversed (from right to left versus from left to right) depending on whether the remote control is to be found mounted on the right or on the left of the steering wheel.

Concerning the rotary movement of the touch zone of the central button, this action is completely independent of the angle of inclination of the steering wheel, and is consequently accessible at any time, unlike a conventional solution of the type comprising a knob or a joystick type lever.

It should be observed that the solution of the invention enables all of the functions to be made available to a thumb, acting on its own without the hand letting go of the steering wheel.

A solution constituted solely by touch sensors would not make it possible to prevent commands being given in involuntary manner. In contrast, associating touch controls with pushbutton switches that act mechanically enables voluntary actions to be sensed and distinguished from mere contact as a result of the proximity of a hand.

FIG. 7 is a flow chart showing the various steps of the algorithm executed by the microcontroller 76 of the remote control 10 in order to analyze the signals delivered by the sensors and the switches.

After a start step 100 and an initialization step 102, the algorithm detects the potential approach of a finger (test 104).

It is considered that a finger has approached if any one of the capacitive touch sensors 52a, 52b, 54a, 54b of the pairs of side buttons 22 and 24, or if any of the sensors 50a to 50d of the central button 20, delivers a signal that exceeds a predetermined threshold. Nevertheless, if a signal is detected simultaneously on a plurality of side capacitive touch sensors 52a, 52b, 54a, 54b, or simultaneously on one of the side sensors 52a, 52b, 54a, 54b and on at least one of the central sensors 50a to 50d, then the situation is not considered as being intended to activate any command and it is not considered as constituting a “finger approach” in the meaning of the algorithm. Such a situation is very likely to correspond to the steering wheel being operated with the user's hand brushing past the casing of the remote control 10, but without having any desire to send a command to the remote telephony or audio equipment.

If the test 104 is negative (no finger approach for sending a command), the microcontroller 76 of the remote control is put on standby (step 106) for a predetermined period, e.g. 125 milliseconds (ms), in order to limit overall electricity consumption. In practice, it suffices to test for the approach of a finger at regular intervals (eight times per second in this example) in order to ensure sufficient detection relative to the user's reaction time.

At the end of the standby period, the microcontroller 76 is re-awakened and the sensors are read (step 108), and then the possible approach of a finger is tested by returning to the test 104.

If the test 104 detects the approach of a finger for the purpose of sending a command, the LEDs 30 and 32 are switched on (step 110) in order to make the remote control easier to use in the dark.

The following step (test 112) consists in detecting a change of state in the switches 60, 62, or 64, i.e. a transition from the released state to the pressed-in state, or vice versa. If such a change of state is detected, and if the switch is one of the side switches 62 or 64, the algorithm determines which of the corresponding touch sensors is active (52a or 52b, or else 54a or 54b, respectively), and it activates the command CMD associated with the corresponding side button (22a or 22b, or else 24a or 24b, respectively) if the transition is from the released state to the pressed-in state. Conversely, if the transition is from the pressed-in state to the released state, then the command CMD is deactivated. If the switch in question is the central switch 60, then the corresponding command is directly activated or deactivated.

The following step (test 116) depends on determining whether or not a command CMD is to be sent, i.e. whether a command has been activated or deactivated in step 114, or not (i.e. no change of state in the switches in step 112):
if a command is to be sent, it is transmitted by the radio transmitter 82 of the remote control 10 to the remote equipment (step 118); or else
it is the raw signals as delivered by the four capacitive sensors 50a to 50d of the multizone central touch pad 50 that are transmitted to the remote equipment (step 120) in order to be interpreted by the remote equipment.

The following step consists in detecting possible withdrawal of the finger (test 122), i.e. the disappearance of the signal from all of the central and side capacitive sensors 50a to 50d and 52a, 52b, 54a, 54b:
if the finger moves away, the algorithm terminates by switching off the LEDs (step 124) and returns to step 104 in order to put the microcontroller on standby until the next time the approach of a finger is detected, etc.; or else
the algorithm returns to the step 112 of testing for a change of state of the switches, in order:
   either to repeat the command, if it was activated on the previous pass through the step 114 and has still not been deactivated (so long as the switch is pressed in, the command is retransmitted at regular intervals to the remote equipment); or else
   to send the new values of the signals from the touch sensors of the central multizone pad, which signals might have changed since the preceding iteration: in order to enable the movement of a finger over said pad to be analyzed and its movement to be described, it is appropriate to send the successive values of the signals from the sensors at relatively short intervals, e.g. once every 10 ms to 15 ms, in order to ensure that the algorithm for analyzing this movement is suitably reactive.

There follows a description of how the signals delivered by the sensors 50a to 50d of the multizone central pad 50 are analyzed.

As mentioned above, the sensor comprises a multizone touch pad 50 having four capacitive sensors 50a to 50d that are distributed in approximately symmetrical manner over four quadrants, thereby producing four sensor signals for analysis.

FIG. 8 shows a typical example of the signal delivered by one of these capacitive sensors 50a to 50d.

More precisely, this figure gives an example of how the output signal S varies as a function of time when a finger is moved to approach the button, makes contact with the button, and then moves over the sensor, and finally moves away.

The approach of the finger is characterized by a sudden increase in the signal with a peak 90 followed by a decrease 92, characteristic of an edge effect. Thereafter, the signal varies as a function of the greater or smaller area of the sensor in contact with or in the proximity of the finger. Withdrawal of the finger is characterized by a sudden drop in the signal, as at 94.

The actual approach of the finger is not confirmed until the decrease 92 is detected, and the portion of the signal that is analyzed is the portion subsequent to the instant t₁ corresponding to the end of this decrease. In comparable manner, withdrawal of the finger is detected by the sudden drop in the signal, as at 94, and values S subsequent to the instant t₂ corresponding to the beginning of this drop are eliminated. The filtered portion of the signal that is analyzed in order to determine the movement of the finger on the central pad is thus the portion that extends between the instants t₁ and t₂.

A signal comparable to that shown in FIG. 8 is obtained for each of the four sensors 50a to 50d. As mentioned above, these values in their raw states are picked up and digitized and then sent as such by the remote control to the remote equipment for analysis.

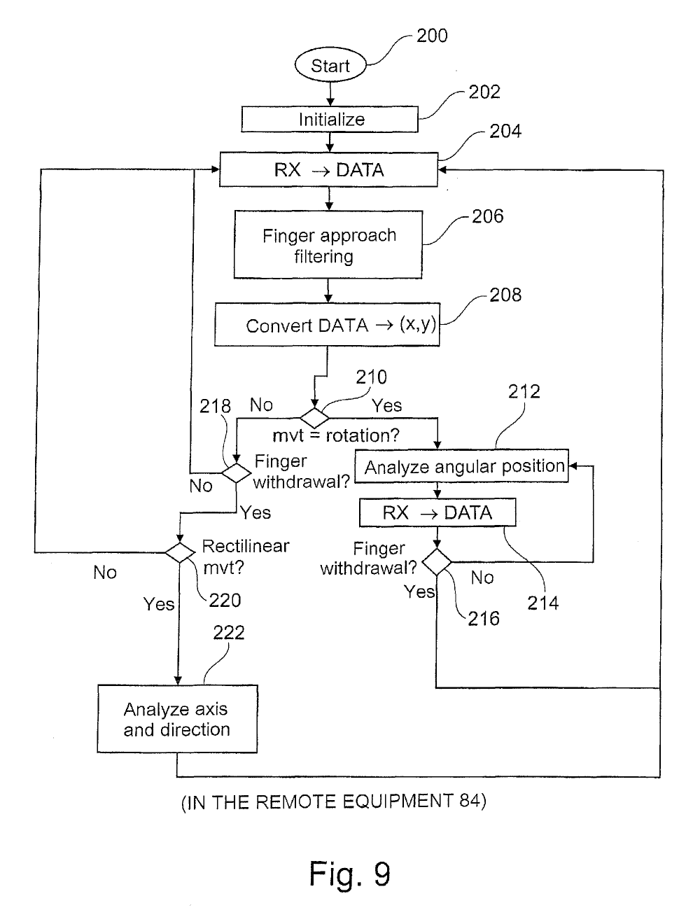

FIG. 9 is a flow chart of the various steps of the algorithm executed by the microcontroller 88 of the remote equipment 84 that is used for performing this analysis of the movement of the finger on the multizone touch pad 50.

After the initial steps (blocks 200 and 202), the algorithm detects that data is being received (step 204), which data, as mentioned above, comprises the four raw digital measurements delivered by the respective touch sensors 50a to 50d at a given instant. This data is initially filtered (step 206) so as to be taken into account only if a decrease is detected in the signal (characteristic decrease 92 in FIG. 8, representative of the approach of a finger) from at least one of the sensors. It is possible for the signal to increase in one or more of the other sensors, depending on the position of the finger on the multizone pad, at the same time as there is a decrease in at least one of the other zones, indicating that a finger has approached and made contact.

The following step (block 208) consists in converting the four signals from the sensors into data concerning two perpendicular directions X and Y. This conversion may be performed using conventional algorithms, which are not described in detail, on the basis of the respective levels of the signals from the four sensors 50a to 50d corresponding to the four quadrants of the multizone pad. In the present situation, it should be observed that it is essentially the movement of the finger that is analyzed, being detected by comparing in pairs the raw data measurements as transmitted successively by the remote control, i.e. detecting the relative variations of the signals from one sampling instant to the next (specifically and as mentioned above, at intervals of 10 ms to 15 ms). Thus, by way of example, a relative variation between the signals from the sensors 50a and 50d is representative of variation in the movement of the finger along the X axis, whereas relative variation between the signals from the sensors 50c and 50d is representative of variation along the Y axis.

The following step (test 210) consists in determining whether the movement is a rotation: if variations are detected simultaneously along the X and the Y axes, then the variation is interpreted as being a rotation.

If the movement is a rotation, then the algorithm proceeds with analysis (step 212) for determining the approximate angular position of the finger on the multizone pad on the basis of the four signals from the sensors 50a to 50d. Thereafter, the algorithm waits to receive new data sent by the remote control (step 214), and if the finger has not moved away (test 216) it analyzes the new angular position (repeating step 212), and so on, so as to define a succession of points corresponding to the rotary movements of the finger over the central button 20. Rotation is taken to be a succession of small individual movements in translation without the finger losing contact; on the basis of the movement as detected in this way, the algorithm can determine the direction and the amplitude of the rotation, so as to generate a command for increasing or decreasing the sound volume of the equipment (or for scrolling through a menu, or for performing some other command of the same kind).

More precisely, once the algorithm detects rotary movement of the finger that exceeds a certain threshold, it considers that the user is requesting an action, which action is represented by a sound volume step, up or down depending on the direction of the movement. The position reached is then considered as a new starting point, and the analysis is reiterated until the threshold is crossed once more, etc.

The withdrawal of the user's finger is detected in step 216 by a sudden drop in the signal (as at 94 in FIG. 8) that appears simultaneously on all four sensors. The algorithm then waits to receive new data (return to step 204).

If in step 210 the algorithm finds that the movement of the finger is not rotary movement, then the algorithm tests whether or not the finger has moved away (test 218, identical to above-described test 216). If the finger has not moved away, then the algorithm returns to step 204 in order to acquire new data, until withdrawal of the finger is detected.

On the basis of the successively acquired values, the algorithm then determines whether the movement was indeed of a rectilinear kind (test 220). This determination is performed by considering at least three points of the movement, typically the first point, the last point, and a point situated approximately in the middle, and verifying whether these three points are in alignment (to within some uncertainty threshold):
if the movement is indeed rectilinear, then the algorithm analyzes the X or Y axis and the direction along that axis (step 222) and generates a corresponding command for the circuits of the equipment: next/preceding track, etc.; or else
if the test is negative, this means that the movement (which in any event has not been found to be a rotary movement) is too erratic to be interpreted correctly. No action is undertaken and the algorithm waits to receive new data (return to block 204).

What is claimed is:

1. A wireless remote control with a touch interface for hands-free telephone and multimedia equipment, of a motor vehicle, the remote control comprising:
a casing having a body supporting a visible face having a plurality of zones forming control buttons with a plurality of touch sensors associated with each of said buttons;
means for selectively producing control signals as a function of a corresponding button actuated by a user; and
radio transmitter means for transmitting messages to remote equipment containing said control signals;
wherein:
the visible face includes a central button and at least one pair of side buttons arranged on a side of the casing;
the remote control further comprises a set of electromechanical pushbutton switches, with one side switch in common for the buttons in each pair of side buttons;
the visible face is movable and/or deformable relative to the body of the casing in such a manner as to enable each side switch to be actuated selectively by exerting a force on one or the other of the buttons in the pair of side buttons corresponding to the switch;
the central button comprising a multizone touch pad that is activatable in different manners as a function of the movement of a finger of the user over the surface of the pad; and
the remote control includes selector means suitable, on detecting a state transition of a side switch, for selecting a control signal as a function of that one of the touch sensors that is activated by contact being made with one of the side buttons of the pair of buttons associated with the switch.

2. The remote control of claim 1, including two pairs of side buttons arranged symmetrically on either side of the central button, with each pair having a common side switch associated therewith.

3. The remote control of claim 1, wherein the central button is movable and/or deformable in the pressing-in direction relative to the body of the casing, and a central electromechanical pushbutton switch is also provided that can be actuated by pressing in said central button.

4. The remote control of claim 1, wherein the central button extends in a mean plane that is set back relative to the middle mean of the control buttons in the visible face of the casing.

5. The remote control of claim 1, wherein said visible face is formed on a cover of the body of the casing, the cover carrying two pairs of side buttons that are arranged symmetrically on either side of the central button, and being hinged to the body of the casing about a pivot axis that extends along a diameter of the central button and that forms an axis of symmetry for the two pairs of side buttons.

6. The remote control of claim 1, wherein means are provided for analyzing the movement of a user's finger over the surface of the multizone touch pad, said means being suitable for distinguishing between a rectilinear movement and a circular movement of the finger, and for determining the direction of said circular or rectilinear movement.

7. The remote control of claim 6, wherein an accelerometer is also provided that is suitable for determining the orientation of the casing of the remote control in an absolute frame of reference, and, where necessary, for reversing said direction of the rectilinear movement, as indicated, as a function of said orientation.

8. The remote control of claim 6, wherein the means for analyzing said movement are means implemented by a circuit incorporated in the casing.

9. The remote control of claim 6, wherein the radio transmitter means are suitable for transmitting signals representative of said movement of a user's finger over the surface of the multizone touch pad, so as to enable said movement to be analyzed by means implemented by a circuit of the remote equipment.

10. The remote control of claim 1, including means for inhibiting the production of said control signals in the event of simultaneously detecting: i) a movement of a user's finger over the surface of the multizone touch pad; and ii) a contact on at least one of the touch sensors associated with the side buttons.

11. The remote control of claim 1, wherein the touch sensors are capacitive sensors, and means are provided for periodically reading the states of said sensors and for activating the means for producing the control signals and the radio transmitter means only in the event of detecting activation of one of the capacitive sensors as a result of contact by a user's finger.

12. The remote control of claim 1, further including lighting means associated with each pair of side buttons, and means for selectively and temporarily activating the lighting means on the approach of a user's finger being detected by one of the touch sensors associated with said buttons.
